(19) United States
(12) Patent Application Publication
(10) Pub. No.: US 2012/0047496 A1
(43) Pub. Date: Feb. 23, 2012

(54) SYSTEM AND METHOD FOR REFERENCE-COUNTING WITH USER-DEFINED STRUCTURE CONSTRUCTORS

(76) Inventors: Damian Rouson, Berkeley, CA (US); Karla Morris, Oakland, CA (US); Huiyong Xia, Markham (CA)

(21) Appl. No.: 13/197,118

(22) Filed: Aug. 3, 2011

Related U.S. Application Data
(60) Provisional application No. 61/374,964, filed on Aug. 18, 2010.

(51) Int. Cl. G06F 9/45

(52) U.S. Cl. 717/151

(57) ABSTRACT

A system is provided that includes a code-processing portion, an initializing-processing portion, an ID-processing portion, a request-processing portion and a compiling-processing portion. The code-processing portion can embed a code architecture into user-defined data structures, wherein the code architecture can manage a counter. The initializing-processing portion can process code having a user-defined constructor therein and can initialize the counter based on an invocation of the architecture. The ID-processing portion has a memory that can store data therein, wherein the data is defined by the user-defined constructor. The ID-processing portion can associate the data with an identification tag and can generate a processing request. The request-processing portion can process the data based on the processing request. The compiling-processing portion can compile the code architecture. The initializing-processing portion can further update the counter based on the processing request. The memory can further store the processed data. The compiling-processing portion can free a portion of the memory holding the processed data when the counter reaches a predetermined number.

### RELATED APPLICATIONS

The present application claims priority from U.S. Provisional Application No. 61/374,964 filed Aug. 18, 2010, the entire disclosure of which is incorporated herein by reference.

### STATEMENT OF GOVERNMENT INTEREST

The United States Government has a paid-up license in this invention and the right in limited circumstances to require the patent owner to license others on reasonable terms as provided for by the terms of contract no. DE-AC04-94AL85000 awarded by the U.S. Department of Energy to Sandia Corporation.

### BACKGROUND

In computer science, a type system may be defined as “a tractable syntactic framework for classifying phrases according to the kinds of values they compute.” A type system associates types with each computed value. By examining the flow of these values, a type system attempts to prove that no type errors can occur. The type system in question determines what constitutes a type error, but a type system generally seeks to guarantee that operations expecting a certain kind of value are not used with values for which that operation does not make sense.

A programming language is said to use static typing when type checking is performed during compile-time as opposed to run-time. Statically typed languages include Ada, ActionScript 3, C, C++, C#, and Java, and Fortran. Static typing is a limited form of program verification: accordingly, it allows many type errors to be caught early in the development cycle. Static type checkers evaluate only the type information that can be determined at compile time, but are able to verify that the checked conditions hold for all possible executions of the program, which eliminates the need to repeat type checks every time the program is executed. Program execution may also be made more efficient (i.e. faster or taking reduced memory) by omitting runtime type checks and enabling other optimizations.

Some statically typed languages support object-oriented programming, which is a programming paradigm using “objects”—data structures consisting of data fields and methods together with their interactions—to design applications and computer programs. Fortran is one example of a statically typed, compiled, programming language that supports object-oriented programming. An example of object-oriented programming using a statically typed, compiled, programming language will now be described with reference to FIGS. 1A-1D.

FIGS. 1A-1D illustrate a statically typed code architecture 102 and a code-processor 104.

As shown in FIG. 1A, statically typed code architecture 102 includes class 110.

Statically typed code architecture 102 may be implemented as a set of instructions. For purposes of discussion, in this example, let statically typed code architecture 102 be a Fortran program. Class 110 defines data structure 116, methods 118-122, and structure constructors 124-126. Each of methods 118-122 defines a procedure for operating on data structure 116. Each of structure constructors 124-126 produces a new object of the type defined by data structure 116.

Code-processor 104 is a combination of a computing system 106 and a compiler 108 for transforming code architecture 102 for use on computing system 106. For purposes of discussion, in this example, let code-processor 104 be a computing system and a compiler (or set of compilers) that transforms source code written in the programming language of code architecture 102 (the source language) into another computer language (the target language, often having a binary form known as object code). The most common reason for wanting to transform source code is to create an executable program. The name “compiler” is primarily used for programs that translate source code from a high-level programming language, e.g. Fortran, to a lower level language (e.g., assembly language or machine code).

In this example, presume that statically typed code architecture 102 is structured such that one of the structure constructors constructs a new object for later use.

As shown in FIG. 1B, statically typed code architecture 102 additionally includes object 112 and object 114. In particular, in this example, structure constructor 124 has constructed object 112. Object 112 may now be used by other objects within statically typed code architecture 102.

As shown in FIG. 1C, presume that the function of method 120 is to associate object 112 with object 114. In this example, the data of object 112 is to be assigned to object 114. In some statically typed code architectures, it is important to efficiently manage data storage. In Fortran, in particular, a compiler will translate a source-language code architecture into a target-language architecture that removes certain data structures that are no longer needed. In this example, presume that once the data of object 112 is to be assigned to object 114, there is no need to retain the data in object 112. This will be described in greater detail with reference to FIG. 1D.

As shown in FIG. 1D, statically typed code architecture 102 no longer includes object 112, and object 114 is now object 112. Here, once that data has been assigned (copied) to object 114, object 114 is changed—as indicated by the new reference number 128. Further, the target-language code architecture generated by code-processor 104 eliminates the redundant data, within object 112, by eliminating object 112. Accordingly, an amount of memory that was allocated for the data within object 112 is now free. This is a very efficient memory management tool associated with statically typed code architectures, such as Fortran.

However, in some instances the memory management tool associated with statically typed code architectures that use structure constructors as discussed above causes problems. For example, in cases where statically typed code architecture 102 is required to access data created by another code architecture compiled by a companion code-processor, code-processor 104 may unwittingly generate an unwanted removal of data that will critically interfere with the operation of statically typed code architecture 102. As another example, code-processor 102 may unwittingly remove its only reference to data that statistically typed code architecture 102 requires to access data generated by a companion code architecture. This will be described in greater detail with reference to FIGS. 2A-2D.

FIGS. 2A-2D illustrate statically typed code architecture 102, code-processor 104, a companion code architecture 202 and a companion processor 204, wherein companion processor 204 is capable of translating code architecture 202 from a source language to a target language. In this example, for purposes of discussion, let statically typed code architecture 102 be a Fortran program; let code architecture 202 be a C++ program; let processor 104 include a computer system 106 and a Fortran compiler 108; and let companion processor 204 include a computer system 206 and a C++ compiler 208. In this case, statically typed code architecture 102 presents a user interface but does not store large, distributed data structures. On the contrary, in this case, companion code architecture 202 stores large, distributed data structures.

As shown in FIG. 2A, statically typed code architecture 102 includes class 110, method 118, method 120, method 122, structure constructor 124, structure constructor 126, structure finalizer 128, object 112, and object 114, and code architecture 202 includes object 212 and object 214.

Companion code-processor 204 is a combination of a computing system 206 and compiler 208 for transforming companion code architecture 202 for use on computing system 206.

In this figure, similar to FIG. 1B discussed above, structure constructor 124 has constructed object 112, which in turn instructs companion code architecture 202 to construct a companion object 212. Object 212 may now be manipulated indirectly and opaquely by the user of statically typed code architecture 102 as a proximate but hidden consequence of that user's manipulation of object 112. For example, suppose that the function of structure constructor 124 is to create a global inventory of the contents of a distributed cluster of warehouses and to store the global inventory in object 112. In this case, the data of the global inventory, being a large, distributed data structure, does not actually reside in object 112, but is in object 212. As such, object 112 sends message 113 to companion code architecture 202, wherein message 113 instructs code architecture 202 to create object 212 holding the global inventory.

As object 212 has been created by a different processor from object 112, object 212 creates an identifier (ID) that object 112 can pass to companion code architecture 202 as a reference to object 212.

In a similar manner, structure constructor 126 creates object 114 and instructs companion code architecture 202 via message 115 to create companion object 214.

As shown in FIG. 2B, companion code architecture 202 sends the ID for the new object 212 to object 112 via the message 213 and companion code architecture 202 sends the ID for new object 214 via message 215.

In an example embodiment, code architecture 102 corresponds to a Fortran-based architecture, whereas companion code architecture 202 corresponds to a C++-based architecture. Accordingly, on one side, code architecture 102 is able to translate a Fortran-based call feature to a C-based call feature. On the other side, companion code architecture 202 is similarly able to translate a C-based call feature to a C++-based call feature. In this manner, the C-language acts as an intermediary to pass commands between code architecture 102 and companion code architecture 202.

Generally speaking, if code architecture 102 and companion code architecture 202 are different languages they may not be able to bi-directionally communicate. Accordingly, in such situations, code architecture 102 may be designed with a translator, indicated by dotted box 201 that enables bi-directional communication (passing commands) between code architecture 102 and companion code architecture 202. In the above discussed example, a translator is not required as a result of the C-language intermediary. Otherwise, any known translator system may be used.

As shown in FIG. 2C, the ID in object 112 refers to object 212 as illustrated by link 217 and the ID in object 114 refers to object 214 by the link 219. Similar to the situation discussed above with reference to FIG. 1C, presume the function of method 120 is to copy object 112 into object 114.

As shown in FIG. 2D, similar to the situation discussed above with reference to FIG. 1D, processor 104 has instructed code architecture 102 to eliminate the redundant object 112. In this example, code architecture 102 includes a structure finalizer 128. The function of structure finalizer 128 is to free memory associated with an object that has been eliminated by code-processor 104. In particular, structure finalizer 128 frees all memory that the processor does not automatically free.

As object 212 has been created by a different processor from object 112, structure finalizer 128 instructs companion code architecture 202 via message 221 to eliminate the linked object 212 and to free all memory allocated for data within object 212. Accordingly, an amount of memory that was allocated for the data within object 212 is now free. Unfortunately, processor 104 does not know that object 212 only passed an ID, referring object 112 to the data of object 212, as opposed to actually passing the data of object 212. Accordingly, when processor 104 instructs code architecture 202 to eliminate object 212, code architecture 202 eliminates the only copy of the data—in this example, the only copy of the global inventory of a distributed cluster of warehouses.

As shown in FIG. 2D, statically typed code architecture 102 no longer includes object 112, and object 114 is now object 130. At this point, object 130 does not have the actual data corresponding to the global inventory of the warehouses. Object 130 only has an ID, pointing to the data of object 212. However, structure finalizer 128 had instructed code architecture 202 to eliminate object 212. Accordingly, object 130 has an ID referencing nothing. As such, statically typed code architecture 102 will be unable to perform its intended function.

As further shown in FIG. 2D, statistically typed code architecture 102 no longer includes a link 219 to object 214. At this point, code architecture 102 has overwritten the ID that established link 219. As such, statically typed code architecture 102 has neither a mechanism manipulating object 214 nor a method for informing code architecture 214 to free the memory allocated for object 214.

What is needed is a system and method to enable a statically typed code architecture to use objects that reference companion objects in external code architectures.

### BRIEF SUMMARY

The present invention provides a system and method to enable a statically typed code architecture to use objects that reference companion objects in external code architectures.

In accordance with an aspect of the present invention, a system is provided that includes a code-processing portion, an initializing-processing portion, an ID-processing portion, a request-processing portion and a compiling-processing portion. The code-processing portion can embed a code architecture into user-defined data structures, wherein the code architecture can manage a counter. The initializing-processing portion can process code having a user-defined constructor therein and can initialize the counter based on an invocation of the architecture. The ID-processing portion has a memory that can store data therein, wherein the data is defined by the user-defined constructor. The ID-processing portion can associate the data with an identification tag and can generate a processing request. The request-processing portion can process the data based on the processing request. The compiling-processing portion can compile the code architecture. The initializing-processing portion can further update the counter based on the processing request. The memory can further store the processed data. The compiling-processing portion can free a portion of the memory holding the processed data when the counter reaches a predetermined number.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF DESCRIPTION OF THE DRAWINGS

The accompanying drawings, which are incorporated in their entirety, illustrate an exemplary embodiment of the present invention and, together with the description, serve to explain the principles of the invention. In the drawings:

FIGS. 1A-1D illustrate a statically typed code architecture and a code-processor;

FIGS. 2A-2D illustrate the statically typed code architecture and compiler of FIG. 1 in addition to another code architecture;

FIGS. 3A-3C illustrate a statically typed code architecture and a compiler in accordance with aspects of the present invention;

FIG. 4 illustrates computing hardware (e.g., computer system) upon which example embodiments in accordance with the present invention may be implemented;

FIG. 5 illustrates a chip set upon which an embodiment of the invention may be implemented;

FIG. 6 illustrates an example embodiment of a processor in accordance with aspects of the present invention; and

FIG. 7 illustrates an example method of reference-counting to manage structure constructors, in accordance with aspects of the present invention.

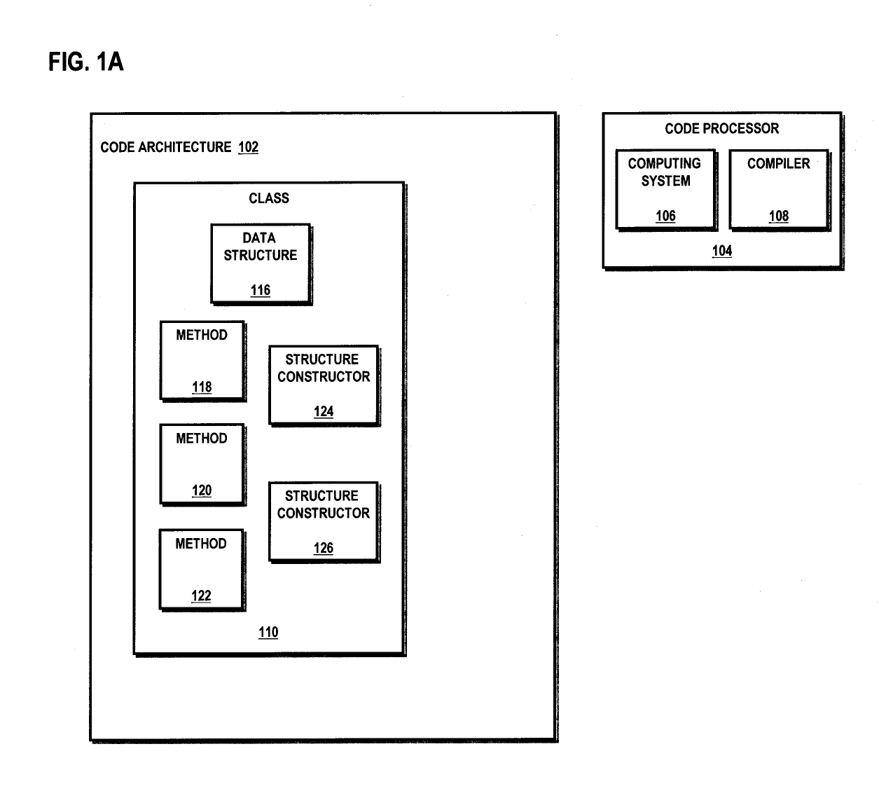

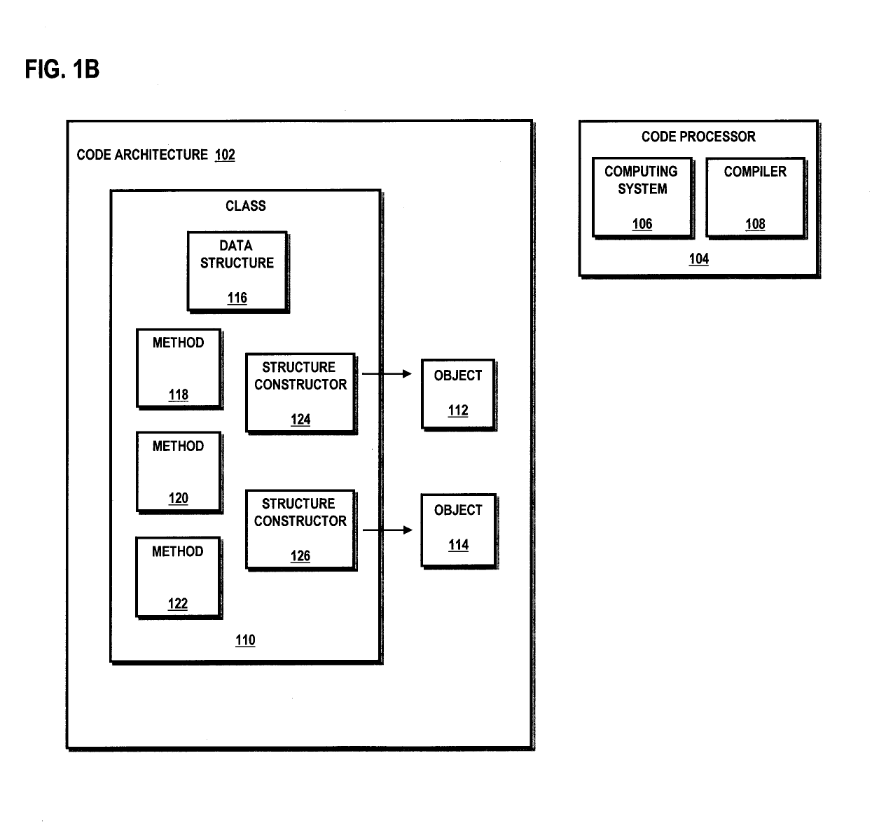

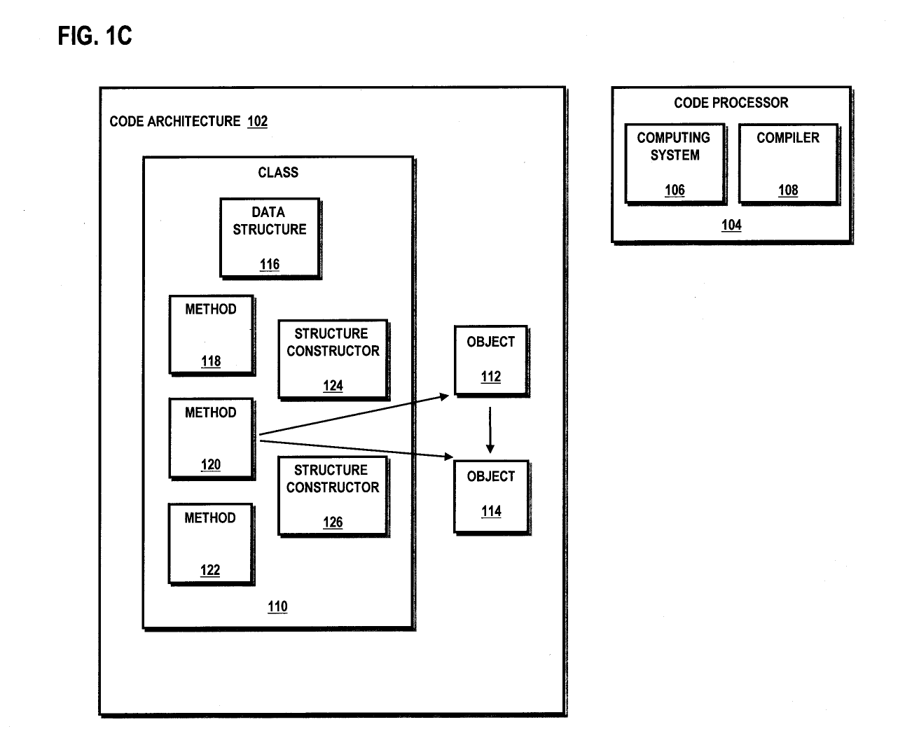

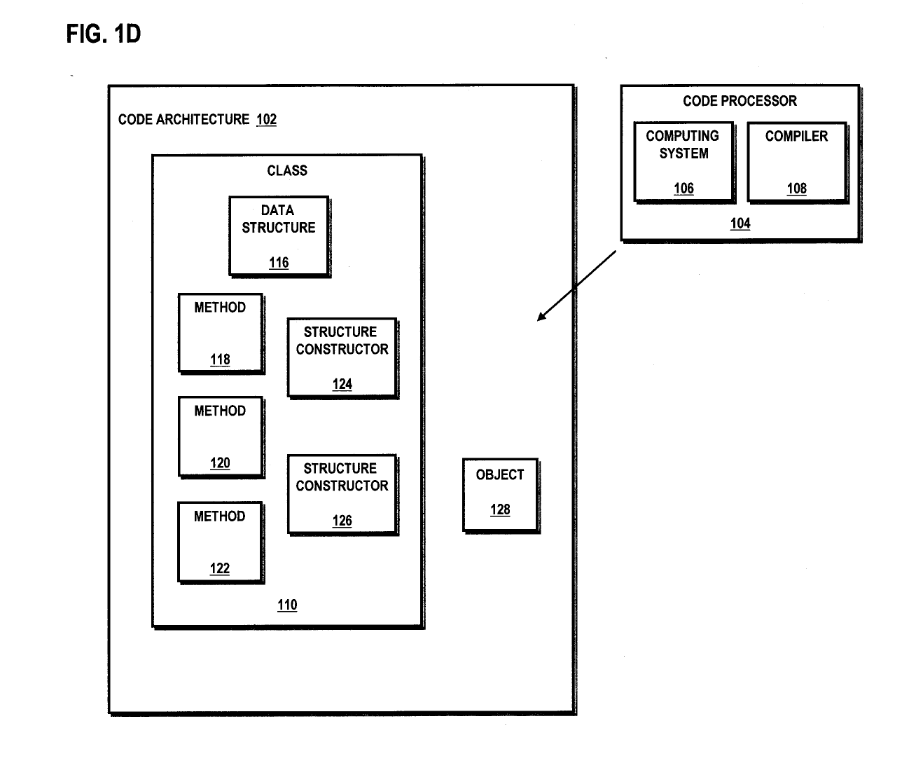

### DETAILED DESCRIPTION OF ONE OR MORE EMBODIMENTS

Fortran 2003 intrinsic structure constructors take the form of functions that return temporary objects that must be assigned to a permanent object before they can be referenced in subsequent code. The language semantics preclude use of these structure constructors when object data components are private and do not have default initializations. The language semantics further provide for user-defined structure constructors in lieu of intrinsic structure constructors. User-defined structure constructors may hold private data structures. User-defined structure constructors need not rely upon default initialization of held data. The language semantics further require finalization of the aforementioned temporary object upon completion of the assignment. When the object serves as a shadow representation of a stateful object in another language, finalization can have catastrophic consequences, destroying the data during the construction process. This technical advance puts forth an object-oriented software architecture that prevents this catastrophe by embedding a reference-counting architecture in user-defined data structures.

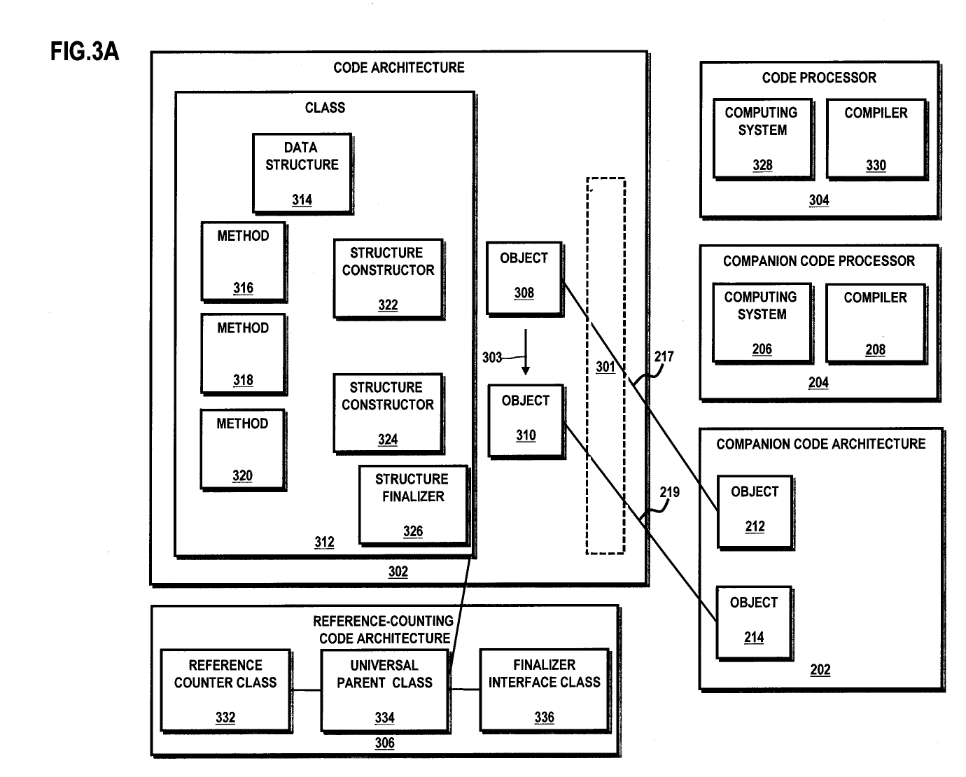

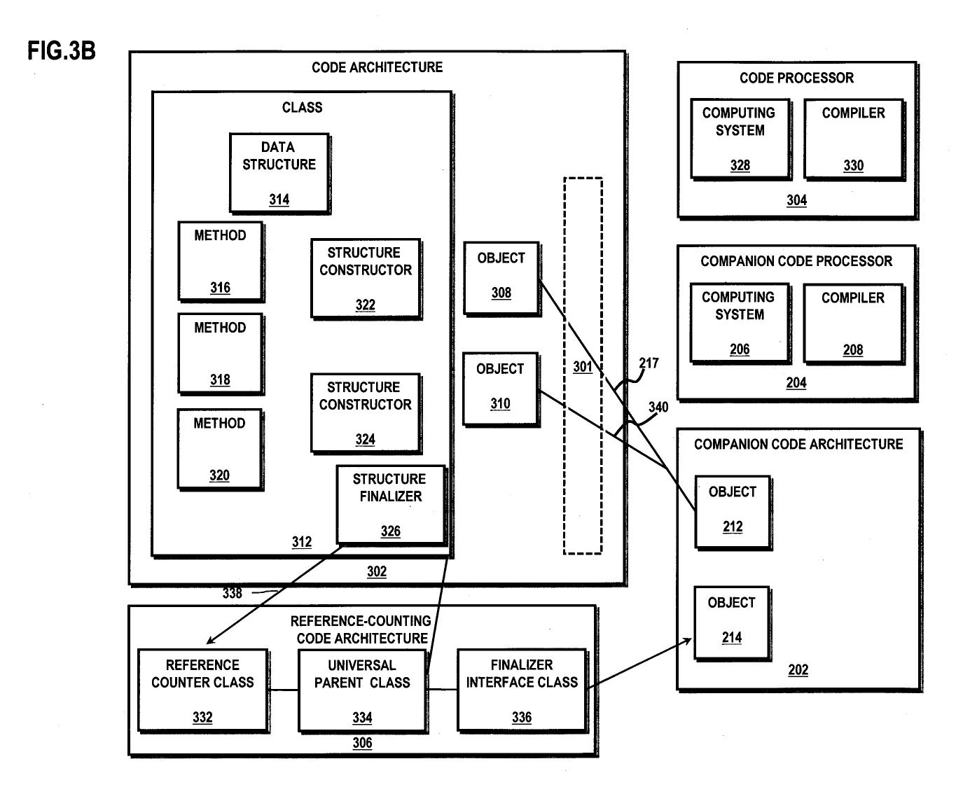

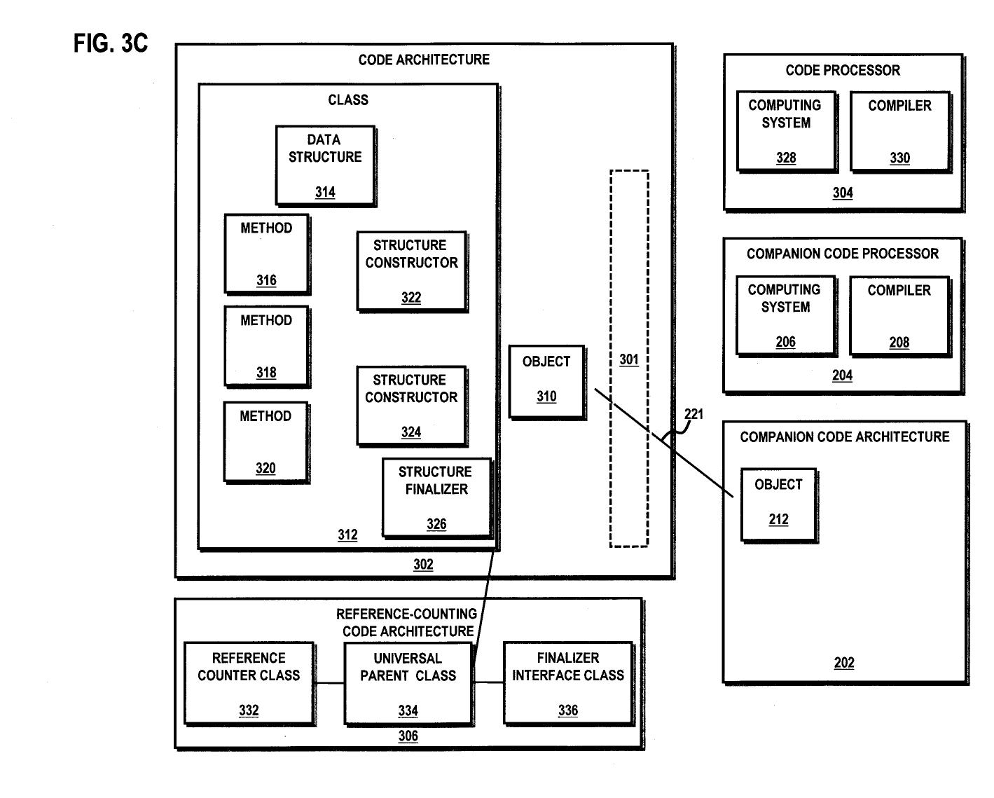

Aspects of the present invention will now be described with reference to FIGS. 3A-3C and FIGS. 4-7.

FIGS. 3A-3C illustrate a statically typed code architecture 302, a code-processor 304 and a reference-counting code architecture 306 in accordance with aspects of the present invention, in addition to code-processor 204 and code architecture 202. In this example, for purposes of discussion, let statically typed code architecture 302 be a Fortran program and let code architecture 202 be a C++ program. In this case, statically typed code architecture 302 presents a desired user interface but does not store large, distributed data files. On the contrary, in this case, code architecture 202 stores large, distributed data files.

As shown in FIG. 3A, statically typed code architecture 302 includes an object 308, a object 310, and a class 312. Class 312 includes a data structure 314, a method 316, a method 318, a method 320, a structure constructor 322, a structure constructor 324 and structure finalizer 326. Statically typed code architecture 302 may be implemented as a set of instructions. Class 312 defines data structure 314, methods 316-320, and structure constructors 322-324. Each of methods 316-320 defines a procedure for operating on data structure 314. Each of structure constructors 322-324 produces a new object of the type defined by data structure 314.

Code-processor 304 is a combination of a computing system 328 and a compiler 330 for transforming code architecture 302 for use on computing system 328. For purposes of discussion, in this example, let code-processor 304 be a computing system and a compiler (or set of compilers) that transforms source code written in the programming language of code architecture 302 (the source language) into another computer language (the target language, often having a binary form known as object code).

Reference-counting code architecture 306 includes a reference-counter class 332, a universal-parent class 334 and a finalizer-interface class 336. Reference-counting code architecture 306 is operable to communicate with companion code architecture 202 and code architecture 302.

In an example embodiment, code architecture 302 and reference-counting code architecture 306 may both correspond to a Fortran-based architecture, whereas companion code architecture 202 may correspond to a C++-based architecture. Accordingly, on one side, code architecture 302 is able to translate a Fortran-based call feature to a C-based call feature. On the other side, companion code architecture 202 is similarly able to translate a C-based call feature to a C++-based call feature. In this manner, the C-language acts as an intermediary to pass commands between code architecture 302 and companion code architecture 202.

Generally speaking, if code architecture 302 and companion code architecture 202 are different languages they may not be able to bi-directionally communicate. Accordingly, in such situations, code architecture 302 may be designed with a translator, indicated by dotted box 301 that enables bi-directional communication (passing commands) between code architecture 302 and companion code architecture 202. In the above discussed example embodiment, a translator is not required as a result of the C-language intermediary. Otherwise, any known translator system may be used.

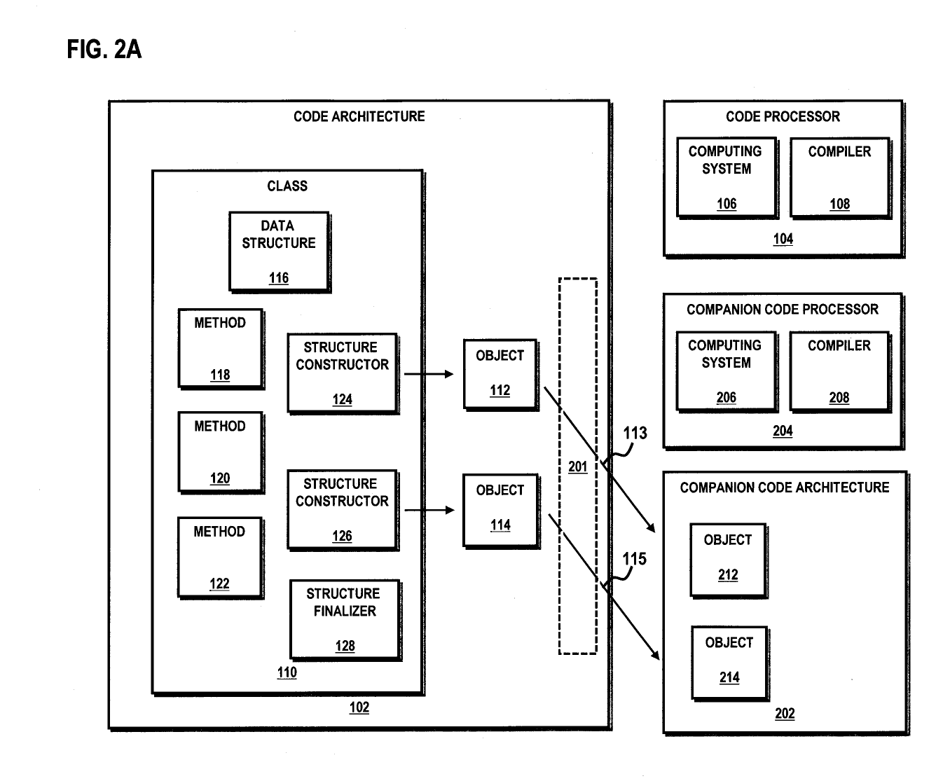

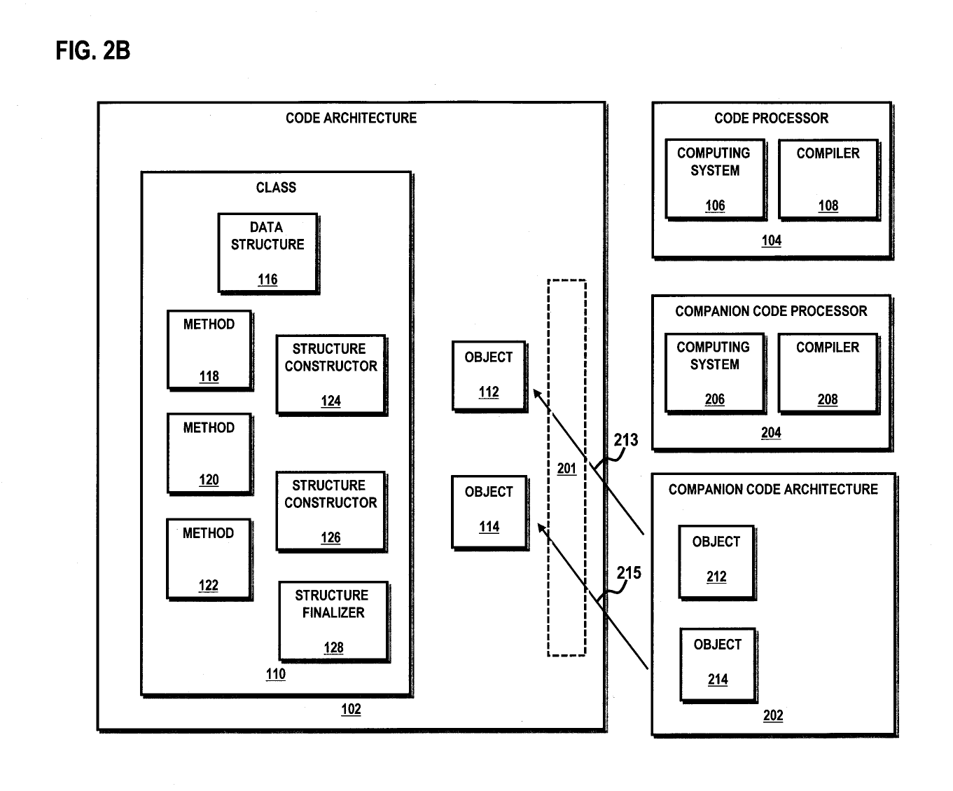

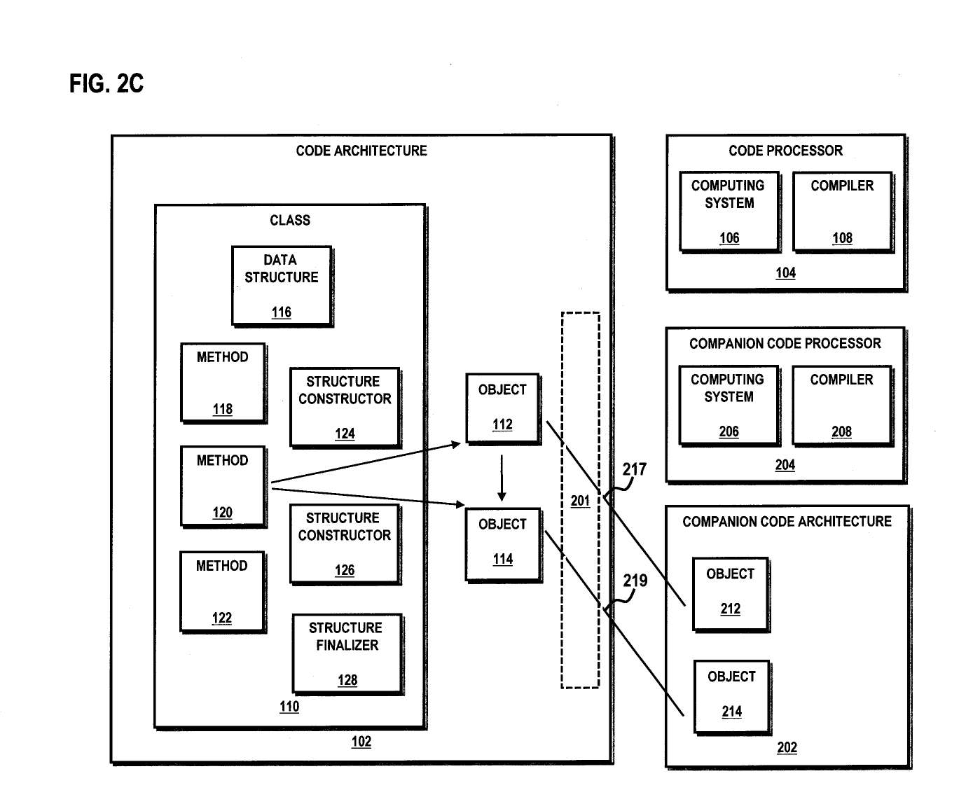

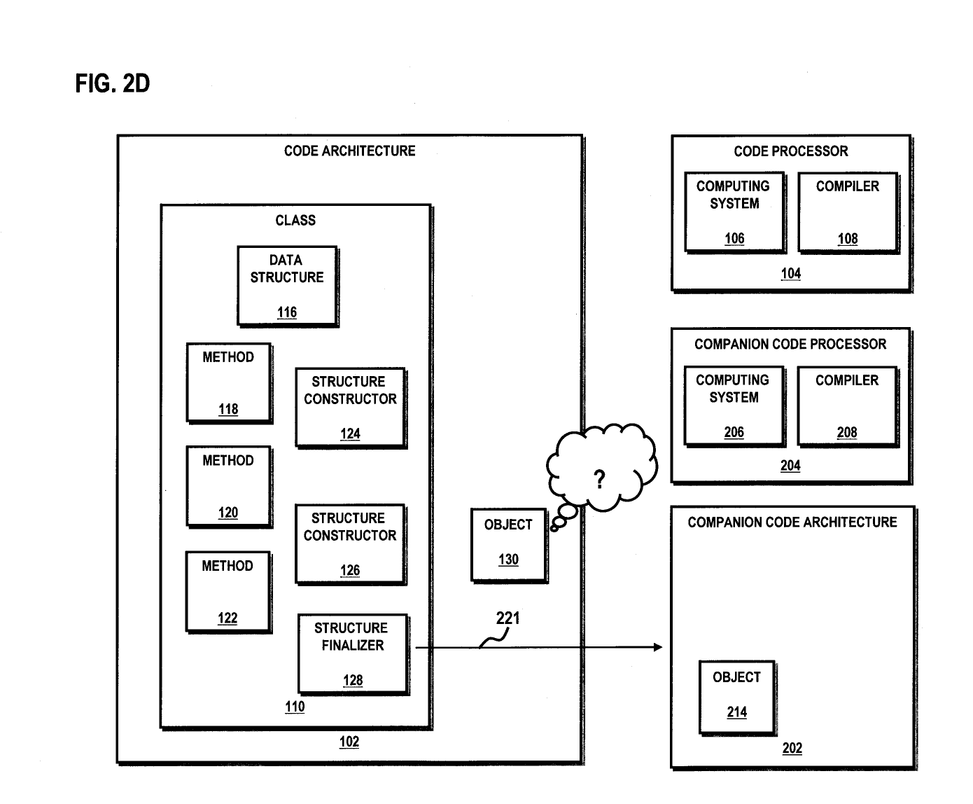

In this figure, similar to FIG. 2B discussed above, structure constructor 322 has constructed object 308 and structure constructor 324 has constructed object 310. Object 308 and object 310 may now be used by other objects within statically typed code architecture 302. For example, suppose that the function of structure constructor 322 is to create a global inventory of the contents of a distributed cluster of warehouses and to store the global inventory in object 308. In this case, the actual data of the inventory of the warehouse is not in object 308, but is in object 212. As such, object 308 requests that companion code architecture 202 create and store the global inventory in object 212.

Contrary to the conventional situation discussed above with reference to FIG. 2A, in accordance with aspects of the present invention, a reference counter is embedded in the constructed structure by exploiting the object-oriented type extension, also known as inheritance. Class 312 extends universal-parent class 334 and thereby inherits the state and behavior of universal-parent class 334. Universal-parent class 334 in turn extends finalizer-interface class 336 and aggregates reference-counter class 332. Universal-parent class 334 inherits from finalizer-interface class 336 the requirement that structure finalizer 326 be defined by any descendent of universal-parent class 334 in order for instances of the descendent class to be constructed.

In this example, object 308 will include a reference counter that will be used by code-processor 304, as will be described in greater detail below.

As object 308 is in a different language from object 212, the actual data, object 212 creates an identifier (ID) that object 308 can pass to code-processor 304 to reference and manipulate the new data.

As shown in FIG. 3B, object 310 acquires a reference to object 212 in the companion code architecture 202 through an assignment operation 303. Assignment operation 303 is described in detail below.

Assignment operation 303 begins with object 310 calling structure finalizer 326 in accordance with Fortran language. Structure finalizer 326 sends message 338 to reference-counter class 332 to remove the reference 219. The reference count value of object 310 is reduced from one (1) to zero (0), causing finalizer-interface class 336 to send a message to companion-code architecture 202 to eliminate object 214. At this point, object 310 no longer holds an ID referring to a valid object in the companion code architecture 202.

Contrary to the assignment operation discussed in FIG. 2C, in accordance with aspects of the present invention, assignment operation 303 establishes a new link 340 connecting object 310 with object 212. Assignment operation 303 also assigns the ID included in object 308 to object 310. This ID value can be passed to code architecture 202 to reference and manipulate the data stored in object 212. Additionally, object 308 and object 310 share the same component of reference-counter class 332. The reference count value is increased from one (1) to two (2).

When assignment operation 303 completes, code-processor 304 instructs code architecture 302 to eliminate object 308 in accordance with Fortran language. Structure finalizer 326 calls reference-counter class 332 to remove the reference 217 for object 308. This causes the reference count value in reference-counter class 332 reduced from two (2) to one (1).

As shown in FIG. 3C, statically typed code architecture 302 no longer includes object 308. Contrary to the conventional situation discussed above with reference to FIG. 2D, in accordance with aspects of the present invention, object 310 retains the link to object 212. Object 310 includes a valid ID and can pass the ID value to the statically typed code architecture 202 to manipulate the data of object 212.

As further shown in FIG. 3C, statically typed code architecture 202 no longer includes object 214. Contrary to the conventional situation discussed above with reference to FIG. 2D, in accordance with aspects of the present invention, companion code-processor 204 reclaims the memory allocated for object 214, rendering efficient memory data management.

As shown in FIG. 3C, contrary to the conventional situation discussed above with reference to FIG. 2C, in accordance with aspects of the present invention, code architecture 202 retains object 212. Here, because object 308 includes a reference counter, compiler 330 does not instructed code architecture 202 to eliminate the redundant data, within object 204, by eliminating object 212.

As shown in FIG. 3C, statically typed code architecture 302 no longer includes object 308. Contrary to the conventional situation discussed above with reference to FIG. 2D, in accordance with aspects of the present invention, object 310 is still able to access the data within object 212, using the ID provided by object 308.

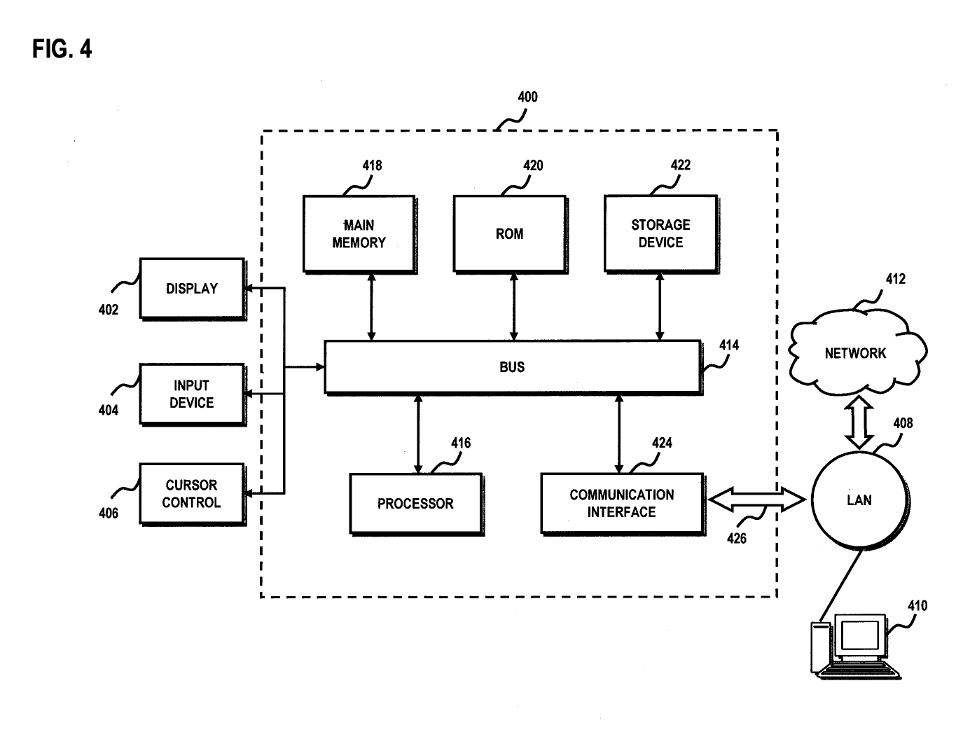

FIG. 4 illustrates computing hardware (e.g., computer system) 400 upon which exemplary embodiments can be implemented. Computer system 400 is in communication with a display 402, an input device 404, a cursor control 406, a local network 408, a host computer 410 and a network 412. Computer system 400 includes a bus 414, a processor 416, a main memory 418, a read-only memory (ROM) 420 and a storage device 422.

In this example, each of bus 414, processor 416, main memory 418, ROM 420 and storage device 422 are distinct devices. However, in other embodiments, at least two of bus 414, processor 416, main memory 418, ROM 420 and storage device 422 may be combined as a unitary device. Further, in some embodiments at least one of bus 414, processor 416, main memory 418, ROM 420 and storage device 422 may be implemented as a non-transitory computer-readable media for carrying or having computer-executable instructions or data structures stored thereon.

Bus 414 or other communication mechanism enables computer system 400 to communicate information and processor 416 coupled to bus 414 enables processing of information. Main memory 418, such as a random access memory (RAM) or other dynamic storage device, coupled to bus 414 enables storing of information and instructions to be executed by processor 416. Main memory 418 can also be used for storing temporary variables or other intermediate information during execution of instructions by processor 416. ROM 420 or other static storage device coupled to bus 414 may be used for storing static information and instructions for processor 416. Storage device 422, such as a magnetic disk or optical disk, is coupled to bus 414 for persistently storing information and instructions.

The computer system 400 may be coupled via bus 414 to display 402, such as a cathode ray tube (CRT), liquid crystal display, active matrix display, or plasma display, for displaying information to a computer user. Input device 404, such as a keyboard including alphanumeric and other keys, is coupled to bus 414 for communicating information and command selections to processor 416. Another type of user input device is cursor control 406, such as a mouse, a trackball, or cursor direction keys, for communicating direction information and command selections to processor 416 and for controlling cursor movement on display 402.

According to an exemplary embodiment, the processes described herein are performed by computer system 400, in response to processor 416 executing an arrangement of instructions contained in main memory 418. Such instructions can be read into main memory 418 from another computer-readable medium, such as storage device 422. Execution of the arrangement of instructions contained in main memory 418 causes processor 416 to perform the process steps described herein. One or more processors in a multi-processing arrangement may also be employed to execute the instructions contained in main memory 418. In alternative embodiments, hard-wired circuitry may be used in place of or in combination with software instructions to implement exemplary embodiments. Thus, exemplary embodiments are not limited to any specific combination of hardware circuitry and software.

Communication interface 424 provides a two-way data communication coupling to network link 426 connected to local network 408. For example, communication interface 424 may be a digital subscriber line (DSL) card or modem, an integrated services digital network (ISDN) card, a cable modem, a telephone modem, or any other communication interface to provide a data communication connection to a corresponding type of communication line. As another example, communication interface 424 may be a local area network (LAN) card (e.g. for ETHERNET™ or an Asynchronous Transfer Model (ATM) network) to provide a data communication connection to a compatible LAN. Wireless links can also be implemented. In any such implementation, communication interface 424 sends and receives electrical, electromagnetic, or optical signals that carry digital data streams representing various types of information. Further, communication interface 424 can include peripheral interface devices, such as a Universal Serial Bus (USB) interface, a PCMCIA (Personal Computer Memory Card International Association) interface, etc. Although a single communication interface 424 is depicted in FIG. 4, multiple communication interfaces can also be employed.

Network link 426 typically provides data communication through one or more networks to other data devices. For example, network link 426 may provide a connection through local network 408 to host computer 410, which has connectivity to network 412 (e.g. a wide area network (WAN) or the global packet data communication network now commonly referred to as the “Internet”) or to data equipment operated by a service provider. Local network 408 and network 412 both use electrical, electromagnetic, or optical signals to convey information and instructions. The signals through the various networks and the signals on network link 426 and through communication interface 424, which communicate digital data with the computer system 400, are exemplary forms of carrier waves bearing the information and instructions.

The computer system 400 can send messages and receive data, including program code, through the network(s), network link 426, and communication interface 424. In the Internet example, a server (not shown) might transmit requested code belonging to an application program for implementing an exemplary embodiment through network 412, local network 408 and communication interface 424. Processor 416 may execute the transmitted code while being received and/or store the code in storage device 422, or other non-volatile storage for later execution. In this manner, the computer system 400 may obtain application code in the form of a carrier wave.

The term “non-transitory computer-readable medium” as used herein refers to any medium that participates in providing instructions to processor 416 for execution. Such a medium may take many forms, including but not limited to computer-readable storage medium (or non-transitory, i.e., non-volatile media and volatile media), and transmission media. Non-volatile media include, for example, optical or magnetic disks, such as storage device 422. Volatile media include dynamic memory, such as main memory 418. Transmission media include coaxial cables, copper wire and fiber optics, including the wires that comprise the bus 414. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

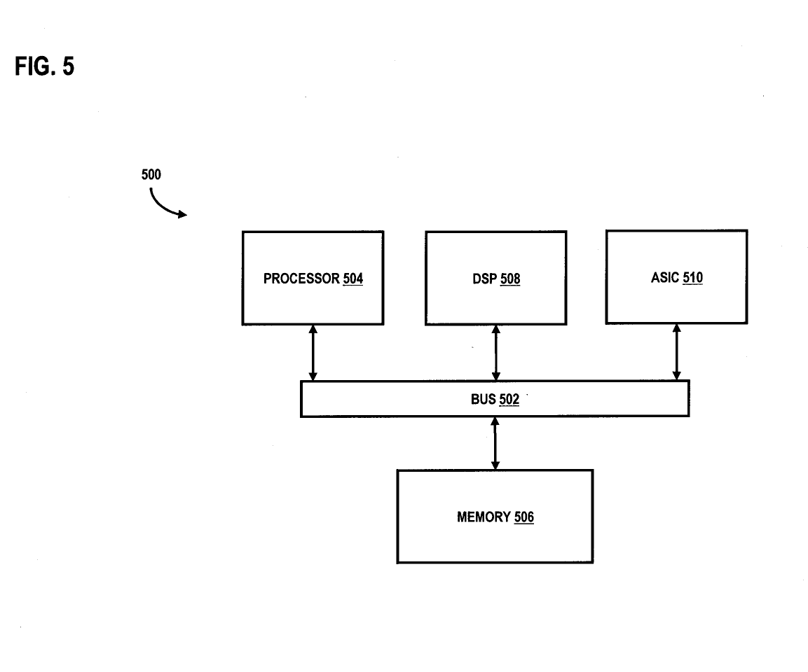

FIG. 5 illustrates a chip set 500 upon which an embodiment of the invention may be implemented.

Chip set 500 includes a bus 502, a processor 504, a memory 506, a digital signal processor (DSP) 508 and an application-specific integrated circuit (ASIC) 510.

In this example, each of bus 502, processor 504, memory 506, DSP 508 and ASIC 510 are distinct devices. However, in other embodiments, at least two of bus 502, processor 504, memory 506, DSP 508 and ASIC 510 may be combined as a unitary device. Further, in some embodiments at least one of bus 502, processor 504, memory 506, DSP 508 and ASIC 510 may be implemented as a non-transitory computer-readable media for carrying or having computer-executable instructions or data structures stored thereon.

Chip set 500 is programmed to present a slideshow as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 500, or a portion thereof, constitutes a means for performing one or more actions in accordance with the present invention

In one embodiment, chip set 500 includes a communication mechanism such as bus 502 for passing information among the components of chip set 500. Processor 504 has connectivity to bus 502 to execute instructions and process information stored in, for example, memory 506. Processor 504 may include one or more processing cores with each core configured to perform independently. A multi-core processor enables multiprocessing within a single physical package. Examples of a multi-core processor include two, four, eight, or greater numbers of processing cores. Alternatively or in addition, processor 504 may include one or more microprocessors configured in tandem via bus 502 to enable independent execution of instructions, pipelining, and multithreading. Processor 504 may also be accompanied with one or more specialized components to perform certain processing functions and tasks such as one or more DSP 508, or one or more ASIC 510. DSP 508 typically is configured to process real-world signals (e.g., sound) in real time independently of processor 504. Similarly, an ASIC 510 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

Processor 504 and accompanying components have connectivity to memory 506 via bus 502. Memory 506 includes both dynamic memory (e.g., RAM, magnetic disk, writable optical disk, etc.) and static memory (e.g., ROM, CD-ROM, etc.) for storing executable instructions that when executed perform the inventive steps described herein to presenting a slideshow via a set-top box. Memory 506 also stores the data associated with or generated by the execution of the inventive steps.

Implementations described herein provide a generic (“one size fits all”) interface gateway (integration layer) that can be used to implement any type of interface for various kinds of systems, such as ERP systems (e.g., SAP, PeopleSoft, etc.), Business Warehouse systems, Legacy systems, web services, business-to-business services, etc. The generic interface gateway includes a services component to implement a plurality of different types of services for processing data received at the interface gateway, the plurality of services being implemented as at least two of an Oracle Data Integration (ODI) service, a SAP service, a Java Web Service, or a Unix shell script. In addition, the generic interface gateway can handle single payload requests, as well as batch request, where the payload is very big. The generic interface gateway may include a metadata-driven orchestration component that acts as the heart of the interface gateway. Users may configure an interface for the interface gateway by configuring the metadata-driven orchestration component to invoke whatever types of services are needed for processing the collected and workflow data. The orchestration component may read the metadata for the given interface to be executed and orchestrate the services in the defined order. The orchestration component may also decide whether the services can be triggered in sequential or parallel mode.

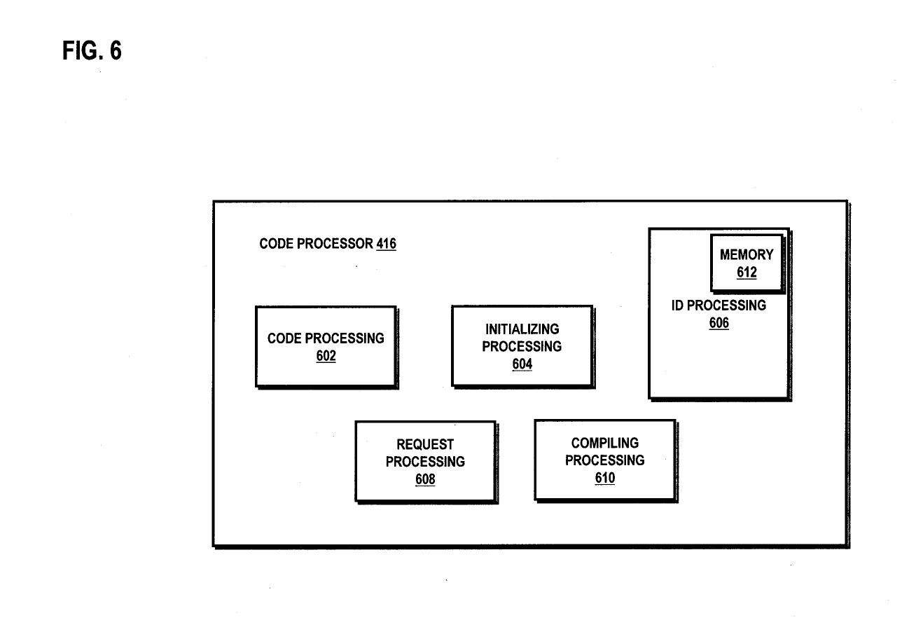

FIG. 6 illustrates an example embodiment of processor 416 in accordance with aspects of the present invention.

As illustrated in the figure, processor 416 includes a code-processing portion 602, an initializing-processing portion 604, an ID-processing portion 606, a request-processing portion 608 and a compiling-processing portion 610.

In this example, each of code-processing portion 602, initializing-processing portion 604, ID-processing portion 606, request-processing portion 608 and compiling-processing portion 610 are distinct devices. However, in other embodiments, at least two of code-processing portion 602, initializing-processing portion 604, ID-processing portion 606, request-processing portion 608 and compiling-processing portion 610 may be combined as a unitary device. Further, in some embodiments at least one of code-processing portion 602, initializing-processing portion 604, ID-processing portion 606, request-processing portion 608 and compiling-processing portion 610 may be implemented as a non-transitory computer-readable media for carrying or having computer-executable instructions or data structures stored thereon.

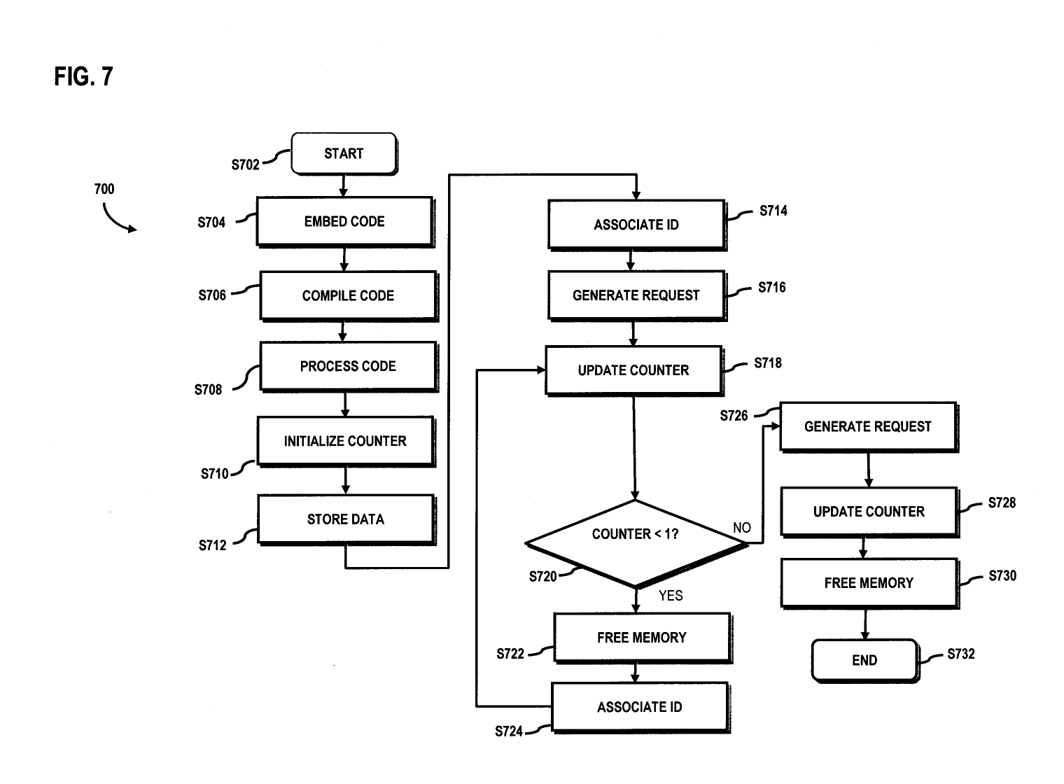

Operation of processor 416 will now be described with reference to FIG. 7.

FIG. 7 illustrates an example method 700 of reference-counting to manage an object creation using user-defined constructor followed by transferring the object reference using an assignment operation, in accordance with aspects of the present invention.

As illustrated in the figure, method 700 starts (S702) and code is embedded (S704). For example, referring to FIG. 6, code-processing portion 602 embeds a code architecture into user-defined data structures, wherein the code architecture manage a counter among other things. For example, referring to FIG. 3A, code-processing portion 602 of code-processor 304 embeds class 312 within code architecture 302 into a user-defined data structure. Recall that class 312 extends universal-parent class 334, which includes reference-counter class 332 and finalizer-interface class 336. Thus class 312 includes reference-counter class 332. Reference-counter class 332 contains and manages a counter. Object 308 and object 310 each is an instance of the user-defined data structure.

Returning to FIG. 7, once the code is embedded, it is compiled (S706). For example, compiling-processing portion 610 may compile code architecture 302. During the compiling process, code architecture 302 is parsed and semantically analyzed by compiler 330 in accordance with the Fortran language. Additional operations may be inserted in accordance to the rules specified by Fortran language. For example, a finalization routine call on the object being assigned to is implicitly inserted at the beginning of each intrinsic assignment operation. At the end of compiling process, an executable file that is operable on computer system 400 is produced.

At the execution time, the compiled code is processed (S708) to include a user-defined constructor. For example, initializing-processing portion 604 processes code having a user-defined constructor. As shown in FIG. 3A, within the code architecture 302, structure constructor 322 and structure constructor 324 each is a user-defined constructor. Furthermore, structure constructor 322 constructs object 308, and structure constructor 324 constructs object 310.

Returning to FIG. 7, when the user-defined constructor is processed, a counter is initialized (S710). For example, within an invocation on the code architecture, initializing-processing portion 604 additionally initializes the counter via the user-defined constructor. As shown in FIG. 3A, based on an invocation of code architecture 302, initializing-processing portion 604 invokes structure constructor 322 to constructs object 308. During the construction of object 308, initializing-processing portion 604 further instructs reference-counter class 332 to initialize the counter value to one (1) for object 308. The same initialization processing also applies to the construction of object 310.

The data is then created and stored (S712). In an example embodiment, ID-processing portion 606 includes a memory 612 for storing data. The data to be stored in memory 612 is defined by the user-defined constructor as provided by initializing-processing portion 604. For example, as shown in FIG. 3A, during the construction of object 308 via structure constructor 322, companion code-processor 204 creates memory 612 and processes the data based on the request from structure constructor 322. The data is then stored in object 212 in companion code architecture 202. Similarly during the construction of object 310, object 214 is created to store the data for object 310.

An ID tag is then associated with the object (S714). ID-processing portion 606 can then associate the data with an ID tag. For example, as shown in FIG. 3A, after the data is stored in object 212, an ID tag is created within companion code architecture 202. This ID tag is then passed to object 308 to be used to associate the data stored in object 212. As shown in the FIG. 3A, link 217 represents the association between object 308 and object 212. Similarly a separate ID tag is created by the companion code architecture 202 and is passed to object 310. Link 219 represents the association between object 310 and object 214.

A request is then generated (S716). ID-processing portion 606 can generate a processing request. For example, in FIG. 3A, at the beginning of the assignment operation 303 to transfer an identification (ID) tag from object 308 to object 310, ID-processing portion 606 generates a processing request to release the association 219.

Once a request is generated, the counter is updated (S718). Request-processing portion 608 processes the data based on the processing request generated by ID-processing portion 606. For example, in FIG. 3B, upon receiving the processing request generated by ID-processing portion 606, code architecture 302 removes link 219 associating object 310 and object 214. Code architecture 302 further invokes compiling-processing portion 610 to update object 310.

Compiling-processing portion 610 compiles the code architecture. For example, in FIG. 3B, compiling-processing portion 610 compiles code architecture 302 in accordance with the Fortran language. As required by the Fortran language, compiling process portion 610 invokes structure finalizer 326 on object 310.

Initializing-processing portion 604 additionally updates the counter in code-processing portion 602, based on the processing request generated by ID-processing portion 606. For example, as shown in FIG. 3B, structure finalizer 326 sends reference-counter class 332 a request to update the counter for object 310. Reference-counter class 332 decrements the counter value by one (1). At this point, the counter value for object 310 becomes zero (0).

It is then determined whether the counter is less than a predetermined threshold (S720). For example, reference-counter class 332 may maintain and check the counter value for each object.

If it is determined that the counter is less than the predetermined threshold (YES in S720) then the memory is freed (S722). For example, returning to FIG. 3B, data corresponding to object 310 is stored in object 214 of companion code architecture 202. Compiling-processing portion 610 can free a portion of memory 612 that is holding the processed data when the counter in code-processing portion 602 reaches a predetermined number. For example, in FIG. 3B, when the counter value for object 310 reaches zero, code-processing portion 602 sends a request to finalizer-interface class 336 to invoke compiling-processing portion 610. Compiling-processing portion 610 invokes companion code-processor 204 to free the memory 612 held by object 214 in companion code architect 202.

An ID is then associated with the stored data (S724). For example, ID-processing portion 606 can associate the data with an identification (ID) tag. Further, ID-processing portion 606 can additionally generate a processing request. For example, as shown in FIG. 3B, during the assignment operation to transfer an ID tag from object 308 to object 310, ID-processing portion 606 copies the ID tag from object 308 to object 310. Further, ID-processing portion 606 associates object 310 with the data stored in memory 612 that is held in object 212. At this point, object 308 and object 310 share the same counter. Then ID-processing portion 606 generates a processing request to initializing-processing portion 604 to update counter for object 310.

Then the counter is again updated (S718). For example, initializing-processing portion 604 additionally updates the counter in code-processing portion 602, based on the processing request generated by ID-processing portion 606. For example, as shown in FIG. 3B, upon receiving process request from processing portion 606, the reference-counter class 332 of initializing-processing portion 604 increments counter value for object 310 by one. Now the counter value becomes two (2).

It is then determined whether the counter is less than a predetermined threshold (S720). For example, reference-counter class 332 may maintain and check the counter value for each object.

If it is determined that the counter is not less than the predetermined threshold then a request is generated to remove redundant object 308 (S726). ID-processing portion 606 can additionally remove an ID tag associated with the data, and generate a processing request. For example, as shown in FIG. 3C, after the assignment operation to transfer an ID tag from object 308 to object 310, ID-processing portion 606 removes the ID tag from object 308 and then removes link 217. Then ID-processing portion 606 generates a processing request to remove object 308 from code architecture 302.

Then the counter is updated a final time (S728). Initializing-processing portion 604 additionally updates the counter in code-processing portion 602, based on the processing request generated by ID-processing portion 606. For example, as shown in FIG. 3C, upon receiving the processing request from ID-processing portion 606, structure finalizer 326 sends a request to reference-counter class 332 to decrement count value for object 310 by one. At this point, the count value of object 310 becomes one (1).

At this point, the memory associated with object 308 is freed (S730). For example, compiling-processing portion 610 compiles the code architecture. For example, in FIG. 3C, compiling-processing portion 610 compiles the code architecture in accordance with Fortran language. As requested by the Fortran language, object 308 is removed from code architecture 302 when the assignment operation completes.

Method 700 then ends (S732).

Conventional statically typed code architectures that use objects that reference companion objects in external code architectures have a particular flow. Specifically, there are situations where access to the external code architecture is eliminated as a result of an automatic destruction of, what is incorrectly determined to be an obsolete, structure constructor. In accordance with aspects of the present invention, a reference-counting code architecture is created to count references of each structure constructor. With the reference-counting code architecture of the present invention, a structure constructor of a statically typed code architecture will not be eliminated until the count of the reference counter is below a predetermined threshold.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A system comprising:
a code-processing portion operable to embed a code architecture into user-defined data structures, the code architecture being operable to manage a counter;
an initializing-processing portion operable to process code having a user-defined constructor therein and to initialize the counter based on an invocation of the architecture;
an ID-processing portion having a memory operable to store data therein, the data being defined by the user-defined constructor, said ID-processing portion being operable to associate the data with an identification tag and to generate a processing request;
a request-processing portion operable to process the data based on the processing request;
a compiling-processing portion operable to compile the code architecture,
wherein said initializing-processing portion is further operable to update the counter based on the processing request,
wherein said memory is further operable to store the processed data, and
wherein said compiling-processing portion is operable to free a portion of said memory holding the processed data when the counter reaches a predetermined number.

2. The system of claim 1, wherein said code-processing portion, said initializing-processing portion, said ID-processing portion and said request-processing portion comprise a unitary device.

3. The system of claim 2, wherein said code-processing portion is operable to embed a statically typed, compiled programming language.

4. The system of claim 3, wherein said code-processing portion is operable to embed a Fortran code architecture.

5. The system of claim 1, wherein said code-processing portion is operable to embed a statically typed, compiled programming language.

6. The system of claim 5, wherein said code-processing portion is operable to embed a Fortran code architecture.

7. A method comprising:
embedding, via a code-processing portion, a code architecture into user-defined data structures, the code architecture being operable to manage a counter;
compiling, via a compiling-processing portion, the code architecture;
processing, via an initializing-processing portion, code having a user-defined constructor therein;
initializing, via the initializing-processing portion, the counter based on an invocation of the architecture;
associating data with an identification tag via a ID-processing portion having a memory operable to store data therein, the data being defined by the user-defined constructor;
generating, via the ID-processing portion, a processing request;
processing, via request-processing portion, the data based on the processing request;
updating, via the initializing-processing portion, the counter based on the processing request;
storing, via the memory, the processed data; and
freeing, via the compiling-processing portion, a portion of the memory holding the processed data when the counter reaches a predetermined number.

8. The method of claim 7, wherein said embedding, said processing code, said initializing, said associating, said generating, said processing the data and said updating, are performed by a unitary device such that the initializing-processing portion, the ID-processing portion and the request-processing portion comprise the unitary device.

9. The method of claim 8, wherein said embedding, via a code-processing portion, a code architecture into user-defined data structures comprises embedding a statically typed, compiled programming language.

10. The method of claim 9, wherein said embedding a statically typed, compiled programming language comprises embedding a Fortran code architecture.

11. The method of claim 7, wherein said embedding, via a code-processing portion, a code architecture into user-defined data structures comprises embedding a statically typed, compiled programming language.

12. The method of claim 11, wherein said embedding a statically typed, compiled programming language comprises embedding a Fortran code architecture.

13. A tangible computer-readable media having computer-readable instructions stored thereon, the computer-readable instructions being capable of being read by a computer, the tangible computer-readable instructions being capable of instructing the computer to perform the method comprising:
embedding, via a code-processing portion, a code architecture into user-defined data structures, the code architecture being operable to manage a counter;
compiling, via a compiling-processing portion, the code architecture;
processing, via an initializing-processing portion, code having a user-defined constructor therein;
initializing, via the initializing-processing portion, the counter based on an invocation of the architecture;
associating data with an identification tag via a ID-processing portion having a memory operable to store data therein, the data being defined by the user-defined constructor;
generating, via the ID-processing portion a processing request;
processing, via request-processing portion, the data based on the processing request;
updating, via the initializing-processing portion, the counter based on the processing request;
storing, via the memory, the processed data; and
freeing, via the compiling-processing portion, a portion of the memory holding the processed data when the counter reaches a predetermined number.

14. The tangible computer-readable media of claim 13, the computer-readable instructions being capable of instructing the computer to perform said method wherein said embedding, said processing code, said initializing, said associating, said generating, said processing the data and said updating, are performed by a unitary device such that the initializing-processing portion, the ID-processing portion and the request-processing portion comprise the unitary device.

15. The tangible computer-readable media of claim 14, the computer-readable instructions being capable of instructing the computer to perform said method wherein said embedding, via a code-processing portion, a code architecture into user-defined data structures comprises embedding a statically typed, compiled programming language.

16. The tangible computer-readable media of claim 15, the computer-readable instructions being capable of instructing the computer to perform said method wherein said embedding a statically typed, compiled programming language comprises embedding a Fortran code architecture.

17. The tangible computer-readable media of claim 13, the computer-readable instructions being capable of instructing the computer to perform said method wherein said embedding, via a code-processing portion, a code architecture into user-defined data structures comprises embedding a statically typed, compiled programming language.

18. The tangible computer-readable media of claim 17, the computer-readable instructions being capable of instructing the computer to perform said method wherein said embedding a statically typed, compiled programming language comprises embedding a Fortran code architecture.
